(19) United States
(12) Patent Application Publication
(10) Pub. No.: US 2019/0172069 A1
(43) Pub. Date: Jun. 6, 2019

(54) Computer-based Understanding of Customer Behavior Patterns for Better Customer Outcomes

(71) Applicant: discourse.ai, Inc, Dallas, TX (US)

(72) Inventor: Jonathan E. Eisenzopf, Dallas, TX (US)

(73) Assignee: discourse.ai, Inc., Dallas, TX (US)

(21) Appl. No.: 16/210,081

(22) Filed: Dec. 5, 2018

Related U.S. Application Data
(60) Provisional application No. 62/594,616, filed on Dec. 5, 2017.

(51) Int. Cl. G06Q 30/00; H04M 3/51; G06N 5/04

(52) U.S. Cl. CPC G06Q 30/016; H04M 3/5175; G06Q 30/04; G06N 5/043; H04M 3/5183

(57) ABSTRACT

An improved data processing system that continuously analyzes and automates a process of identifying statistically significant patterns of customer behavior linked to a specific set of customer outcomes and presenting these visually in a graph with linkages to the root causes, customer events, each step in the customer behavior, and the customer outcome. The improved computing system provides a set of hypotheses and recommendations based on the pattern matching solutions in a computer database and allows the user of the system to simulate the anticipated outcomes.

This application claims benefit to the filing date of U.S. Provisional Patent Application 62/594,616, our docket DA-17-A002US1, filed on Dec. 5, 2017, by Jonathan E. Eisenzopf. The present invention relates to certain improvements of computer functionality to analyze and understand customer behavior patterns within a business enterprise so that their pathways can be optimized for improved customer outcomes.

### FIELD OF THE INVENTION

### Background of Invention

Every year, large organizations spend a great deal of resources conducting business analysis projects related to understanding customer behavior for the purposes of maximizing profit and providing good customer service. The results of such analysis engagements often drives business strategy that will impact the organization for many years.

### SUMMARY OF THE EXEMPLARY

### Embodiments of the Invention

Disclosed is an improved data processing system that continuously analyzes and automates a process of identifying statistically significant patterns of customer behavior linked to a specific set of customer outcomes and presenting these visually in a graph with linkages to the root causes, customer events, each step in the customer behavior, and the customer outcome. The improved computing system provides a set of hypotheses and recommendations based on the pattern matching solutions in a computer database and allows the user of the system to simulate the anticipated outcomes.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 illustrates an exemplary arrangement, according to the present invention, of computing components and elements to leverage disparate systems and data sources.

FIG. 2 shows, for reference, a hypothetical flow of user experiences interacting with the technology which represents a business entity's enterprise.

FIG. 3 presents an exemplary data structure embodiment for a classifer, according to the present invention, to collect and correlate disparate system events.

FIG. 4 illustrates an exemplary method, according to the present invention, for dominant path analysis.

FIG. 5 sets forth an exemplary results report, according to the present invention, including observations, hypothesis, recommendations, and their estimated impacts resulting from exemplary methods of analysis relative to the examples shown in FIGS. 3 and 4.

### DETAILED DESCRIPTION OF ONE OR MORE EXEMPLARY EMBODIMENT(S) OF THE INVENTION

The present inventor has realized that there is an unmet need in the art of computer-assisted business process analysis. Certain improvements are disclosed herein that improve the computer-based analysis tools through particular user interface enhancements and logical process improvements, while simultaneously improving the utilization of computer usage of computing resources such as memory footprint, processing bandwidth, and communications bandwidth to yield higher levels of simultaneously-served users by a single computing platform, thereby reducing the cost of the service to the operator.

The present inventor has realized that the number of projects that even the largest companies can complete in a year is limited due to the manual time intensive effort required, often across multiple departments. These engagements may involve tens of resources for several months whilst data is collected, analyzed, and reviewed by experienced practitioners. Hypothesis generated from executive interviews, observations, and computer generated reports often must be properly validated to achieve a reasonable degree of reliability in order for the business to decide to invest in the associated project and business plans. And, because the time-consuming nature of the data gathering, data preparing, and analysis, businesses struggle to respond in real-time to changes in customer desires and behaviors.

While businesses and organizations have adopted tools such as central customer database systems and financial forecasting tools to reduce the effort of such engagements, data sets often come from non-integrated disparate sources, requiring additional database and programming efforts at the beginning of the engagement.

Further, even with integrated data sets, the process of conducting root cause analysis, validating assumptions, creating hypothesis or conversation models largely rely upon the practitioner(s) who have experience conducting such analysis and can quickly identify relevant problem/opportunity patterns. Lastly, by the time the results have been completed following months of analysis, business factors may have changed such that the results and assumptions are less relevant.

Based on these realizations, the present inventor has recognized that there is an unmet need in the art for improved and enhanced computer functions to detect, analyze, illustrate, and report customer behaviors while interacting with a business enterprise and the technology that represents the enterprise, to recommend responses to those behaviors to improve the outcomes experienced by the customer, and to measure the change in those behaviors and outcomes to verify or invalidate the modifications to the enterprise.

The inventor has devised an improved data processing system that continuously analyzes and automates a process of identifying statistically significant patterns of customer behavior linked to a specific set of customer outcomes and presenting these visually in a graph with linkages to the root causes, customer events, each step in the customer behavior, and the customer outcome. The improved computing system provides a set of hypotheses and recommendations based on the pattern matching solutions in a computer database and allows the user of the system to simulate the anticipated outcomes.

In the figures to be discussed, the blocks and arrows represent the relationships between the improved data processing systems and the customer behaviors and process flows that are relevant to identifying common customer behavior patterns that correlate to business and customer outcomes and relate to a given set of root causes, according to the methods and processes of the present invention. The invention pertains to a method and system automating a process of identifying and analyzing the relationships between root causes that drive events that cause customer behaviors related to a business or customer outcome that is typically composed of one or more tasks. As such, various embodiments according to the invention are able to automatically and continuously, in real-time in some embodiments, analyze these relationships and to then make specific observations and recommendations based on an expert database, thereby reducing the time a cost of conducting this analysis manually.

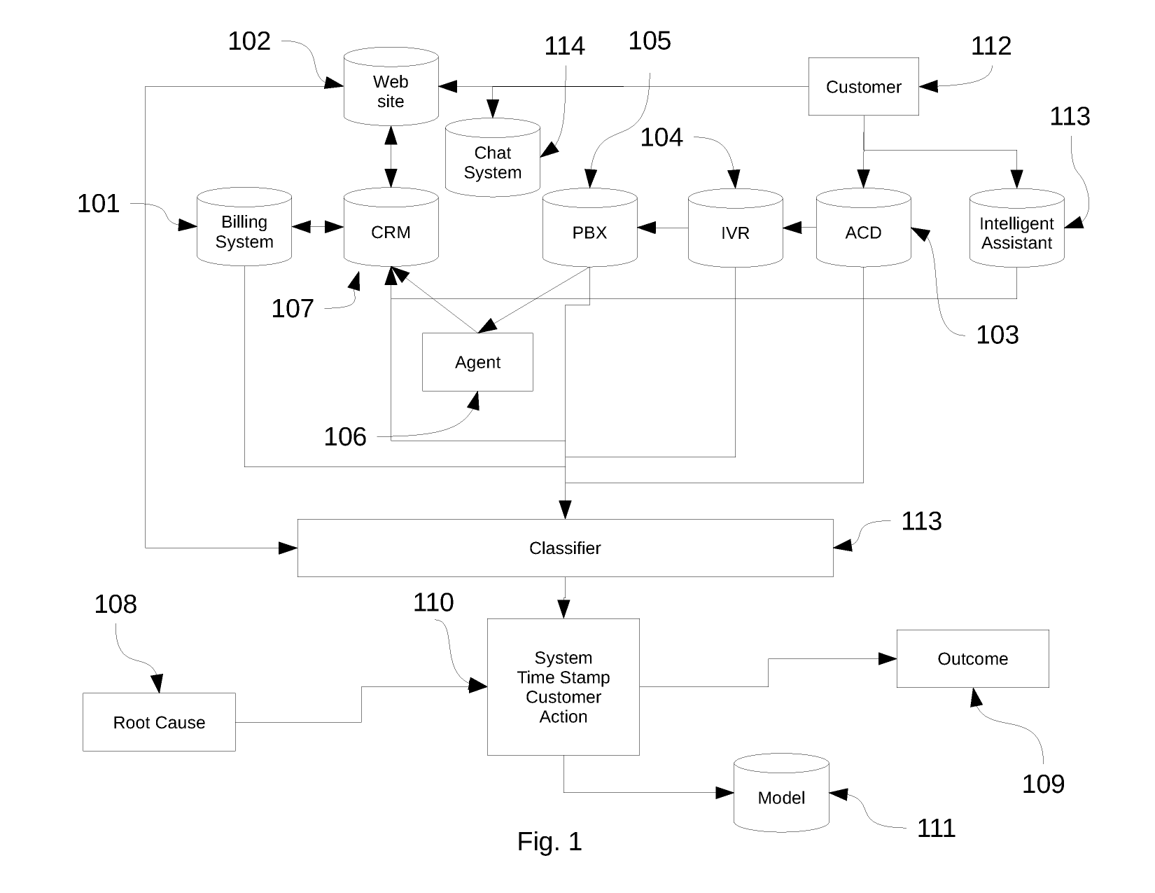

Referring now to FIG. 1, illustrates how a improved data processing system according to the present invention leverages disparate systems that record customer events to identify customer behavior linkages between root causes and customer outcomes into predictive models. The exemplary arrangement of computing components, machine-performed logical processes, and communications networks in FIG. 1 include, but are not limited to, data processing systems that are often present within an organization, such as a billing system 101 that stores information related to a customer's bill, a web site 102 that customers 112 can access to view information about a product or service, access their bill, and conduct customer self-service tasks, and a Customer Relationship Management (CRM) system 107 that stores information regarding customer activity and interactions with the organization.

For customer interactions that involve speaking with an agent 106, calls usually terminate into an Automatic Call Distributor (ACD) 103 where the customer may be routed to an Interactive Voice Response (IVR) 104 system so that the customer has the option for self-service, or directly to an available agent. Customers may also interact with the organization via an Intelligent Assistant 113 such as Amazon Alexa™, Google Home™, or Facebook Messenger™ for self-service which accesses the customer's information in the CRM system 107. In cases where the customer needs to speak directly to an agent, the call is routed to an agent whose phone is connected to a Private Branch eXchange (PBX) 105 in a call center, who is able to facilitate the desired customer and/or business outcome to address the root cause.

Some notable key elements of the improved data processing system, according to the present invention, include a classifier 113, which provides raw data for a model 111 to identify and correlate common customer paths to outcomes 109 related to a root cause 108. Given that the customer behaviors to be analyzed are stored across disparate data processing systems mentioned previously, a beneficial improvement to the computing technology provided by some embodiments of the present invention is its ability to automatically identify and correlate customer behaviors from these disparate systems. This is done, in at least one embodiment, by automatically identifying similarities in the data sets and then inferring relationships. The primary elements of correlation may include a unique customer identifier, one or more session identifiers, and one or more event or record date/time stamps. These elements, along with the content of the data element, may allow the embodiment to create a digital representation or model of customer behavior paths over time.

Customer paths are aggregated, by the improved computing system, by one or more criteria including a unique customer identifier, classes of customers based on attributes such as customer type, lifetime value, total spend, outcomes, events, and root causes. The most common statistically significant paths are automatically compared, by the improved computing system, against one or more domain models 111 which may be stored by the data processing system. The domain models are able to create observations and their associated recommendations to improve customer and business outcomes based on previous outcomes related to the same or similar customer paths. These domain models may be supplied by domain experts or created by the organization wishing to use the invention to improve customer outcomes. The models are automatically improved based on actual outcomes against the predicted outcomes generated by the system.

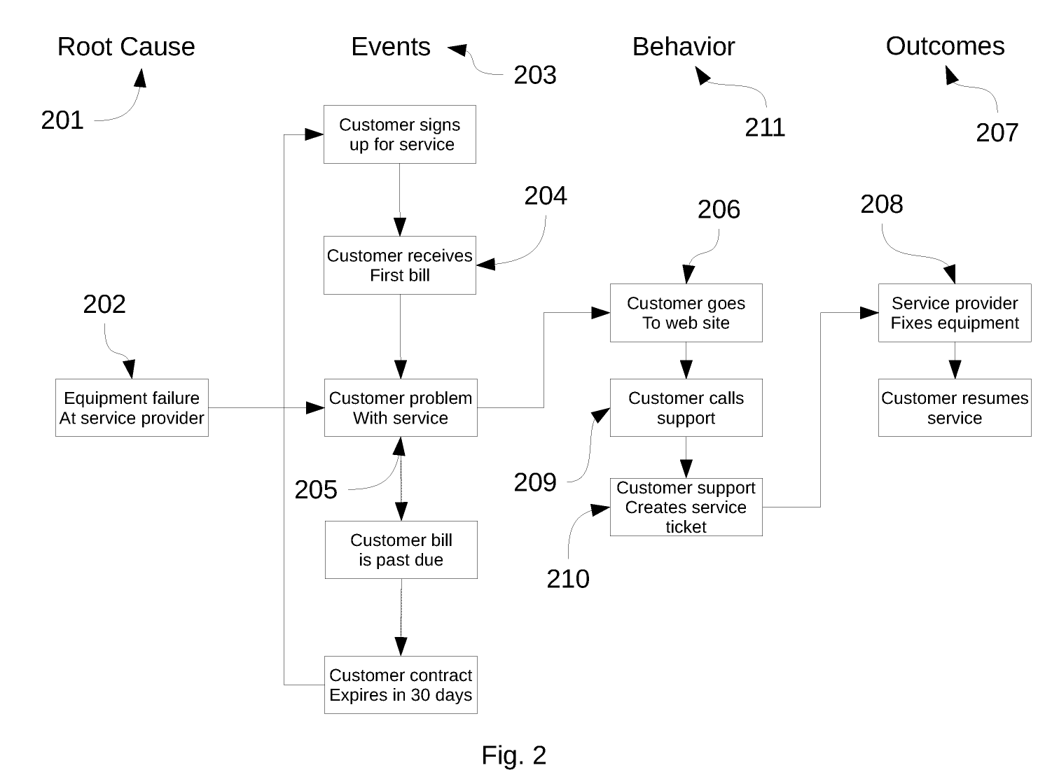

FIG. 2 shows a sample method or process, by the improved computing system, according to the present invention, of how a root cause drives one or more events that result in customer behaviors that cause a customer outcome. This example process includes some or all of an identification of a root cause 201, a computer record of a series of related events 203, a plurality of examples of related customer or provider behaviors 211, and their associated outcomes 207. For example, given a root cause 201 such as an equipment failure 202 that causes an interruption of a customer's service 205 which leads the customer to visit the service provider's web site 206, then event records indicate that those customers with that problem subsequently call customer support 209 who, most often, creates a service ticket 210 in the service provider's system, which most often results in the service provider repairing the customer's equipment 208.

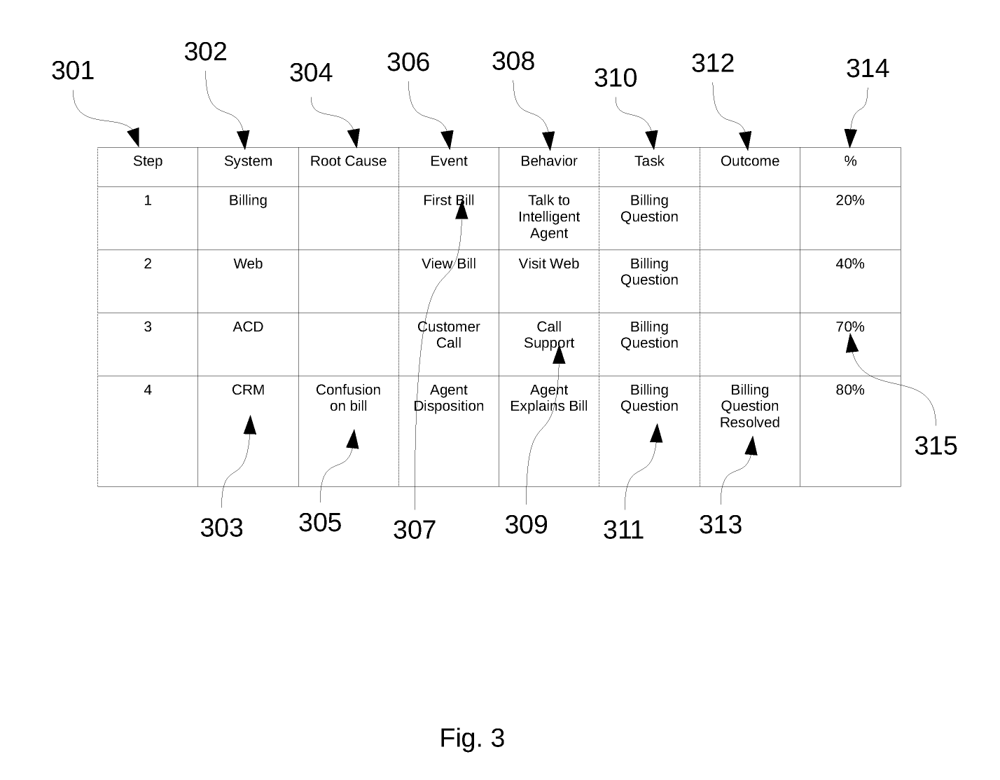

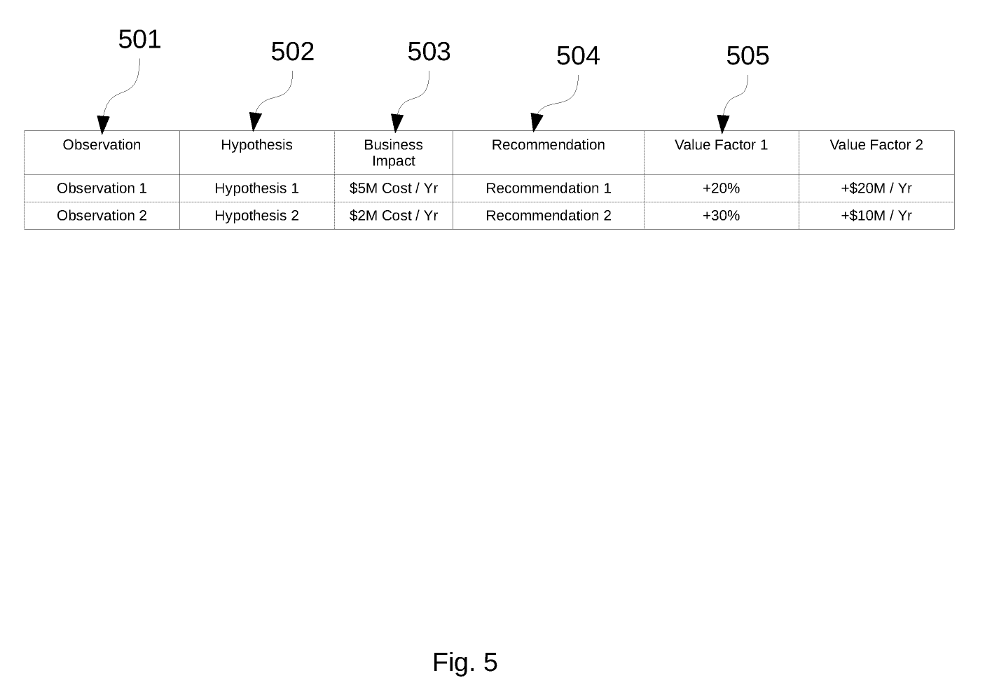

FIG. 3 provides details of an exemplary embodiment according to the present invention for how the classifier or FIG. 1 collects, structures and correlates disparate system event records for customers over time and documents the customer behaviors and tasks associated with those events and behaviors and eventually correlates them to a customer outcome and root cause and measures the percentage of customers that were affected by that specific set of steps. This exemplary embodiment collects and analyzes customer behaviors 308 from disparate systems 302 such as CRM 303 across multiple steps 301 that may occur over the course of time to achieve a given outcome 312 such as resolving a billing question 313. If the digital model accurately predicts the root cause 304 as described in the FIG. 1, such as a customer's confusion of their first bill 305, in addition to tying the steps to the related task 310 performed by the customer or the agent which occurs when the customer calls the organization 309, such as answering the billing question 311, then the automated system will be able to accurately predict what the dominant customer paths will be and their statistical significance 314 given an event 304 such as a customer receiving their first bill 307. In this specific example, the automated and improved data processing system would be able to make the observation that a significant percentage, such as 80%, of customers had their billing question resolved 315. Based on the system generated observation, an associated recommendation and associated estimated benefits would be made, which are further detailed in FIG. 5.

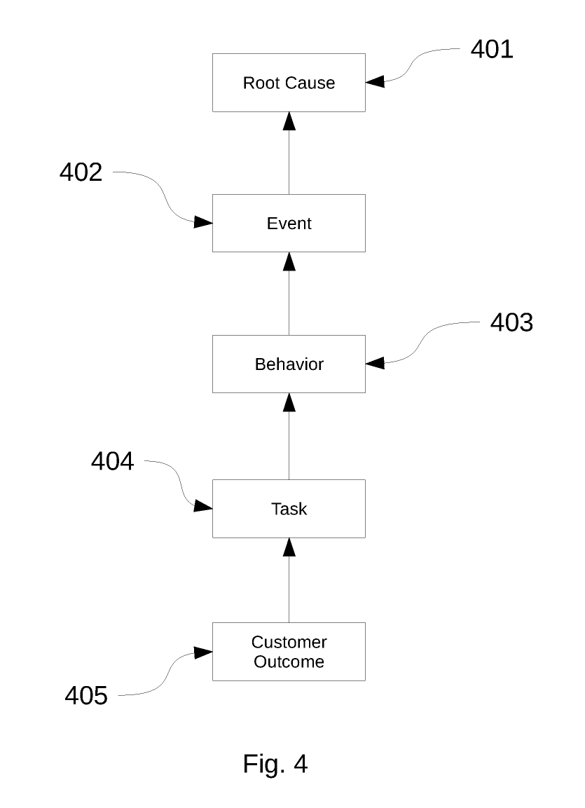

FIG. 4 illustrates an exemplary embodiment according to the present invention of a dominant path analysis process, which starts with a given customer outcome and analyzes customer interactions to identify the most common customer paths that occur to achieve a given outcome given an event and root cause. FIG. 4 further illustrates a path analysis process which at least one embodiment of the invention automatically performs. It begins with a given customer or business outcome 405 and analyzes the data from the systems previously mentioned in FIG. 1 to identify all tasks 404 that were performed by the agent, the Intelligent Agent, or the IVR on behalf of the customer to achieve the outcome. Each step taken to perform the task and the associated customer behaviors 403, examples of which are contained in FIG. 2 and FIG. 3, are further identified and counted such that a tree containing the most statistically significant customer behaviors can be accurately traced to the given outcome. The improved data processing system then attempts to identify the event(s) 402 and associated root cause(s) 401 through direct correlations or probabilistic deduction based on previous instances of the same or similar event 402 and the associated root cause 401 analysis.

FIG. 5 shows an exemplary embodiment of the results of at least one embodiment of the present invention which are communicated to a user or another computer process, including the improved data processing system's observations, hypothesis, recommendations, and their estimated impacts resulting from the analysis in FIG. 3. and FIG. 4. This sample output of the recommendation 504 and benefits model 505 that matches the hypothesis 502 are based on the observations 501 made by the system based on the pattern analysis depicted in FIG. 3 and FIG. 4. as described previously. The associated business impact 503 of the hypothesis is based upon the statistical significance of the observation as contained in FIG. 3. The output contained in FIG. 5 is comprised of data based upon domain experts that input sample outputs for a given domain based on their experience and the expected performance of the recommendations.

The preceding example logical processes may include computer processing hardware to embody systems according to the present invention; may be coupled with tangible, computer readable memory devices to realize computer program products according to the invention; and may be embodied as a machine logic method.

The present invention may be realized for many different processors used in many different computing platforms, including but not limited to “Personal Computers” and web servers, running a popular operating systems such as Microsoft™ Windows™ or IBM™ AIX™, UNIX, LINUX, Google Android™, Apple iOS™, and others, to execute one or more application programs to accomplish the computerized methods described herein, thereby providing the improvement to the computer platform as set forth herein.

The “hardware” portion of a computing platform typically includes one or more processors accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces may be provided, as well as specialty interfaces for specific applications. If the computing platform is intended to interact with human users, it is provided with one or more user interface devices, such as display(s), keyboards, pointing devices, speakers, etc. And, each computing platform requires one or more power supplies (battery, AC mains, solar, etc.).

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Certain embodiments utilizing a microprocessor executing a logical process may also be realized through customized electronic circuitry performing the same logical process(es). The foregoing example embodiments do not define the extent or scope of the present invention, but instead are provided as illustrations of how to make and use at least one embodiment of the invention.

1. A method of improving a data processing system comprising:
continuously analyzing, by a processor, customer behavior linked to a specific set of customer outcomes;
identifying, by a processor, statistically significant patterns in the analyzed customer behavior;
matching, by a processor, the statistically significant patterns to one or more potential solutions in a computer database, wherein the potential solutions comprise one or more hypotheses, one or more recommendations, one or more root causes and one or more customer events correlated to the statistically significant patterns of customer behavior;
retrieving, by a processor, the potential solutions from the computer database; and
providing, by a processor, a simulation to a user for the one or more recommendations, wherein the simulation comprises at least one visualized graph having a plurality of linkages between the root causes, the customer events, each step in the customer behavior, and the customer outcome, and wherein the simulation provides a prediction of what one or more dominant customer paths would be with associated statistical significances for one or more specific events.

2. The method as set forth in claim 1 wherein the analyzing of customer behavior comprises identifying and analyzing one or more relationships between potential root causes which drive events that cause customer behaviors related to a business or customer outcome having one or more tasks.

3. The method as set forth in claim 2 wherein the analyzing of one or more relationships comprises, automatically and continuously, making specific observations and recommendations based on an expert database.

4. The method as set forth in claim 1 further comprising determining, by a processor, customer behavior by correlating records, logs, and events from two or more disparate networked systems selected from the group consisting of a billing system, a customer account management web site, a Customer Relationship Management (CRM) system, an Automatic Call Distributor (ACD), an Interactive Voice Response (IVR) system, an Intelligent Assistant device, and a Private Branch eXchange (PBX) in a call center.

5. The method as set forth in claim 4 further comprising classifying, by a processor, using raw data from the two or more disparate networked systems to correlate common customer paths to outcomes related to each root cause in the database.

6. The method as set forth in claim 5 wherein the classifying comprises identifying, by a processor, similarities in data sets of the disparate networked system, and inferring, by a processor, the relationships

7. The method as set forth in claim 1 further comprising:
aggregating, by a processor, a plurality of customer paths according to one or more criteria selected from the group consisting of a unique customer identifier, a class of customers, a customer type, a customer lifetime value, a customer total value spend, a previous outcome, a previous event, and a previous root cause;
comparing, by the processor, statistically common customer paths to one or more domain models;
extracting, by a processor, one or more observations from the comparable domain models; and
revising, by a processor, the domain models to reflect actual customer outcomes to more accurately predict future customer outcomes for similarly correlated tasks and events.

8. A computer program product for improving a data processing system comprising:
a tangible, computer-readable memory device which is not a propagating signal per se; and
program instructions embodied by the tangible, computer-readable memory device for causing a processor to, when executed:
continuously analyze customer behavior linked to a specific set of customer outcomes;
identify statistically significant patterns in the analyzed customer behavior;
match the statistically significant patterns to one or more potential solutions in a computer database, wherein the potential solutions comprise one or more hypotheses, one or more recommendations, one or more root causes and one or more customer events correlated to the statistically significant patterns of customer behavior;
retrieve the potential solutions from the computer database; and
provide a simulation to a user for the one or more recommendations, wherein the simulation comprises at least one visualized graph having a plurality of linkages between the root causes, the customer events, each step in the customer behavior, and the customer outcome, and wherein the simulation provides a prediction of what one or more dominant customer paths would be with associated statistical significances for one or more specific events.

9. The computer program product as set forth in claim 8 wherein the program instructions for analyzing of customer behavior comprise program instructions to identify and analyze one or more relationships between potential root causes which drive events that cause customer behaviors related to a business or customer outcome having one or more tasks.

10. The computer program product as set forth in claim 9 wherein the analyzing of one or more relationships comprises, automatically and continuously, making specific observations and recommendations based on an expert database.

11. The computer program product as set forth in claim 8 wherein the program instructions further comprise program instructions to determine customer behavior by correlating records, logs, and events from two or more disparate networked systems selected from the group consisting of a billing system, a customer account management web site, a Customer Relationship Management (CRM) system, an Automatic Call Distributor (ACD), an Interactive Voice Response (IVR) system, an Intelligent Assistant device, and a Private Branch eXchange (PBX) in a call center.

12. The computer program product as set forth in claim 11 wherein the program instructions further comprise program instructions to classify using raw data from the two or more disparate networked systems to correlate common customer paths to outcomes related to each root cause in the database.

13. The computer program product as set forth in claim 12 wherein the classifying comprises identifying similarities in data sets of the disparate networked system, and inferring, by a processor, the relationships

14. The computer program product as set forth in claim 8 wherein the program instructions further comprise program instructions to:
aggregate a plurality of customer paths according to one or more criteria selected from the group consisting of a unique customer identifier, a class of customers, a customer type, a customer lifetime value, a customer total value spend, a previous outcome, a previous event, and a previous root cause;
compare statistically common customer paths to one or more domain models;
extract one or more observations from the comparable domain models; and
revise the domain models to reflect actual customer outcomes to more accurately predict future customer outcomes for similarly correlated tasks and events.

15. An improved a data processing system comprising:
a computer processor;
a tangible, computer-readable memory device which is not a propagating signal per se; and
program instructions embodied by the tangible, computer-readable memory device for causing the computer processor to, when executed:
continuously analyze customer behavior linked to a specific set of customer outcomes;
identify statistically significant patterns in the analyzed customer behavior;
match the statistically significant patterns to one or more potential solutions in a computer database, wherein the potential solutions comprise one or more hypotheses, one or more recommendations, one or more root causes and one or more customer events correlated to the statistically significant patterns of customer behavior;
retrieve the potential solutions from the computer database; and
provide a simulation to a user for the one or more recommendations, wherein the simulation comprises at least one visualized graph having a plurality of linkages between the root causes, the customer events, each step in the customer behavior, and the customer outcome, and wherein the simulation provides a prediction of what one or more dominant customer paths would be with associated statistical significances for one or more specific events.

16. The improved a data processing system as set forth in claim 15 wherein the program instructions for analyzing of customer behavior comprise program instructions to identify and analyze one or more relationships between potential root causes which drive events that cause customer behaviors related to a business or customer outcome having one or more tasks.

17. The improved a data processing system as set forth in claim 16 wherein the analyzing of one or more relationships comprises, automatically and continuously, making specific observations and recommendations based on an expert database.

18. The improved a data processing system as set forth in claim 15 wherein the program instructions further comprise program instructions to determine customer behavior by correlating records, logs, and events from two or more disparate networked systems selected from the group consisting of a billing system, a customer account management web site, a Customer Relationship Management (CRM) system, an Automatic Call Distributor (ACD), an Interactive Voice Response (IVR) system, an Intelligent Assistant device, and a Private Branch eXchange (PBX) in a call center.

19. The improved a data processing system as set forth in claim 18 wherein the program instructions further comprise program instructions to classify using raw data from the two or more disparate networked systems to correlate common customer paths to outcomes related to each root cause in the database.

20. The improved a data processing system as set forth in claim 19 wherein the classifying comprises identifying similarities in data sets of the disparate networked system, and inferring, by a processor, the relationships
